(19) United States
(12) Patent Application Publication
(10) Pub. No.: US 2011/0157162 A1
(43) Pub. Date: Jun. 30, 2011

(54) IMAGE PROCESSING DEVICE, IMAGE PROCESSING METHOD, AND PROGRAM

(76) Inventors: Toshiya HAMADA, Saitama (JP); Tatsumi Sakaguchi, Kanagawa (JP); Naohisa Kitazato, Tokyo (JP); Mitsuru Katsumata, Tokyo (JP); Hiroyuki Suzuki, Kanagawa (JP)

(21) Appl. No.: 12/968,740

(22) Filed: Dec. 15, 2010

(30) Foreign Application Priority Data
Dec. 28, 2009 (JP) P2009-297547

(51) Int. Cl. G06T 15/00

(52) U.S. Cl. 345/419

(57) ABSTRACT

An image processing device includes a left-eye sub image generation unit that generates a left-eye sub image constituting a sub image for 3D display together with a right-eye sub image, a right-eye sub image generation unit that generates the right-eye sub image, a left-eye trajectory image generation unit that generates an image of a left-eye trajectory region that is a region including a trajectory region, as a left-eye trajectory image, a right-eye trajectory image generation unit that generates an image of a right-eye trajectory region that is a region including a trajectory region, as a right-eye trajectory image, and a superposition unit that superposes the left-eye sub image and the left-eye trajectory image on a left-eye main image constituting a main image for 3D display together with a right-eye main image, and superposes the right-eye sub image and the right-eye trajectory image on the right-eye main image.

### BACKGROUND OF THE INVENTION

1. Field of the Invention

The present invention relates to an image processing device, an image processing method, and a program. In particular, the present invention relates to an image processing device, an image processing method, and a program that can reduce user's eye strain when a 3D sub image is synthesized with a 3D main image and the synthesized image is displayed.

2. Description of the Related Art

A 2D image is predominantly used as a content of a movie or the like, but a 3D image has attracted increasing attention recently.

As a reproduction device which reproduces a 3D content, a device which generates caption data for 3D display based on caption data for 2D display and displays a 3D caption based on the caption data for 3D display is provided. The caption data for 2D display is composed of bitmap image data (referred to below as merely image data) of a caption image and a display position. Here, the caption image is assumed to be an image of a rectangular region including the whole caption which is displayed on a single screen.

In such reproduction device, as shown in FIG. 1, left-eye caption data among caption data for 3D display is generated by shifting a display position of caption data for 2D display in one direction (a right direction in the example of FIG. 1) in a horizontal direction (a left-right direction) by a predetermined offset amount offset. Further, right-eye caption data is generated by shifting the display position of the caption data for 2D display in another direction (a left direction in the example of FIG. 1) in the horizontal direction by a predetermined offset amount offset.

Then, image data of a left-eye caption image is superposed on image data of a left-eye main image among image data of the main image of a movie or the like for 3D display based on the left-eye caption data, and image data of a right-eye caption image is superposed on image data of a right-eye main image based on the right-eye caption data.

Examples of this superposing method include the following two methods.

A first method is that screen data of a caption image for each eye (referred to below as a caption plane) is generated and the caption plane for each eye is superposed on screen data of a main image (referred to below as a video plane).

Specifically, in the first method, when a display position of the upper left of a caption image included in caption data for 2D display is on a position (x, y) on an xy coordinate on a screen as shown in FIG. 2, for example, screen data of a screen in which the upper left of the caption image is arranged on a position (x+offset, y) is generated as a left-eye caption plane. The position (x+offset, y) is obtained by shifting the position (x, y) in a positive direction of the x coordinate by an offset amount offset. Then, the left-eye caption plane is superposed on a left-eye video plane, which is a video plane for a left eye, so as to generate a left-eye plane.

Further, screen data of a screen in which the upper left of the caption image is arranged on a position (x−offset, y) is generated as a right-eye caption plane. The position (x−offset, y) is obtained by shifting the display position (x, y) of the upper left of the caption image, which is included in the caption data for 2D display, in a negative direction of the x coordinate by an offset amount offset. Then, the right-eye caption plane is superposed on a right-eye video plane, which is a video plane for a right eye, so as to generate a right-eye plane.

The second method is that a caption plane is shifted in one direction in the horizontal direction by an offset amount offset so as to superpose the caption plane on a left-eye video plane and the caption plane is shifted in another direction in the horizontal direction by an offset amount offset so as to superpose the caption plane on a right-eye video plane.

Specifically, in the second method, as shown in FIG. 3, a caption plane based on caption data for 2D display is shifted in a positive direction of an x coordinate by an offset amount offset so as to be superposed on a left-eye video plane, thus generating a left-eye plane. Further, the caption plane is shifted in a negative direction of the x coordinate by an offset amount offset so as to be superposed on a right-eye video plane, thus generating a right-eye plane.

Here, regions, in which the caption image is not arranged, of a screen corresponding to the left-eye caption plane and of a screen corresponding to the right-eye caption plane in FIG. 2 and of the caption plane in FIG. 3 are transparent images, and a main image is arranged in the regions of the screens corresponding to the left-eye plane and the right-eye plane.

Further, in the examples of FIGS. 2 and 3, regions other than a caption “ABC” in the caption images are transparent images, and the main image is arranged in the regions of the screens corresponding to the left-eye plane and the right-eye plane as well.

The left-eye plane and the right-eye plane are generated as described above. Then, a left-eye screen is displayed on a display device based on the left-eye plane so as to be seen by a left eye of a user and a right-eye screen is displayed on the display device based on the right-eye plane so as to be seen by a right eye of the user. Accordingly, the user can see a 3D main image in which the 3D caption is synthesized.

For example, as shown in FIG. 4A, when a left-eye caption image is shifted in a right direction by an offset amount offset and a right-eye caption image is shifted in a left direction by an offset amount offset, a focal position comes to a front side (user's side) compared to the display device surface and therefore the caption image is seen popped up.

On the other hand, as shown in FIG. 4B, when the left-eye caption image is shifted in the left direction by the offset amount offset and the right-eye caption image is shifted in the right direction by the offset amount offset, the focal position goes to a back side compared to the display device surface and therefore the caption image is seen pulled in.

Here, FIGS. 4A and 4B are diagrams when a user who watches an image displayed on the display device is viewed from the above. This is applicable also to FIGS. 5A and 5B described later.

Further, a caption image is commonly 3D-displayed at the front side compared to the main image, as shown in FIGS. 5A and 5B.

As other reproduction device which reproduces a 3D content, Japanese Unexamined Patent Application Publication No. 10-327430, for example, discloses a device which synthesizes a 3D telop with a 3D main image and displays the synthesized image.

### SUMMARY OF THE INVENTION

As described above, in a reproduction device which reproduces caption data for 3D display based on caption data for 2D display, a right-eye caption plane and a left-eye caption plane are generated by shifting a display position of a single caption image 1 in left and right directions by the offset amount offset, as shown in FIG. 6A.

Accordingly, a depth direction of a focal position of eyes is changed depending on the right-eye caption plane and the left-eye caption plane and a caption image having no thickness is merely 3D-displayed as shown in FIG. 6B. Thus, a caption image having a thickness is not seen. Further, in a trajectory region 2 which is formed in a right-eye screen when the caption image 1 is shifted by the offset amount offset and a trajectory region 3 which is formed in a left-eye screen when the caption image 1 is shifted by the offset amount offset, the main image is displayed.

Accordingly, as shown in FIG. 6B, the main image which is 3D-displaced at the back side of the caption image is seen from the boundary of the 3D caption image due to the main image of the trajectory region 2 and the trajectory region 3, for example, frequently changing the focal position of user's eyes. Consequently, the user gets eye strain.

It is desirable to reduce user's eye strain when a 3D sub image is synthesized with a 3D main image and the synthesized image is displayed.

According to an embodiment of the present invention, there is provided an image processing device including a left-eye sub image generation means for generating a left-eye sub image of the left-eye sub image and a right-eye sub image that constitute a sub image for 3D display, by shifting a display position of a sub image for 2D display in a predetermined direction by a predetermined amount, a right-eye sub image generation means for generating the right-eye sub image by shifting the display position of the sub image for 2D display in a direction opposite to the predetermined direction by the predetermined amount, a left-eye trajectory image generation means for generating an image, which has a predetermined color of low transparency, of a left-eye trajectory region that is a region including a trajectory region, which is formed when the display position of the sub image for 2D display is shifted in the predetermined direction by the predetermined amount, as a left-eye trajectory image, a right-eye trajectory image generation means for generating an image, which has a predetermined color of low transparency, of a right-eye trajectory region that is a region including a trajectory region, which is formed when the display position of the sub image for 2D display is shifted in the direction opposite to the predetermined direction by the predetermined amount, as a right-eye trajectory image, and a superposition means for superposing the left-eye sub image and the left-eye trajectory image on a left-eye main image of the left-eye main image and a right-eye main image that constitute a main image for 3D display, and for superposing the right-eye sub image and the right-eye trajectory image on the right-eye main image.

An image processing method and a program according to another embodiment of the present invention corresponds to the image processing device of the embodiment of the present invention.

In the other embodiment of the present invention, a display position of a sub image for 2D display is shifted in a predetermined direction by a predetermined amount so as to generate a left-eye sub image of the left-eye sub image and a right-eye sub image that constitute a sub image for 3D display, the display position of the sub image for 2D display is shifted in a direction opposite to the predetermined direction by the predetermined amount so as to generate the right-eye sub image, an image, which has a predetermined color of low transparency, of a left-eye trajectory region that is a region including a trajectory region, which is formed when the display position of the sub image for 2D display is shifted in the predetermined direction by the predetermined amount, is generated as a left-eye trajectory image, an image, which has a predetermined color of low transparency, of a right-eye trajectory region that is a region including a trajectory region, which is formed when the display position of the sub image for 2D display is shifted in the direction opposite to the predetermined direction by the predetermined amount, is generated as a right-eye trajectory image, and the left-eye sub image and the left-eye trajectory image are superposed on a left-eye main image of the left-eye main image and a right-eye main image that constitute a main image for 3D display, and the right-eye sub image and the right-eye trajectory image are superposed on the right-eye main image.

The image processing device according to the embodiment of the present invention may be an independent device or an internal block constituting one device.

According to the embodiments of the present invention, user's eye strain can be reduced when a 3D sub image is synthesized with a 3D main image and the synthesized image is displayed.

### BRIEF DESCRIPTION OF THE DRAWINGS

FIG. 1 illustrates a method for generating caption data for 3D display;

FIG. 2 illustrates a first method for superposing a caption image on a main image;

FIG. 3 illustrates a second method for superposing a caption image on a main image;

FIGS. 4A and 4B illustrate an appearance of a 3D caption image;

FIGS. 5A and 5B illustrate a positional relationship between a caption image and a main image in a depth direction;

FIGS. 6A and 6B illustrate an appearance of a main image on which a caption image is superposed;

FIG. 7 is a block diagram showing a configuration example of an image processing device according to an embodiment of the present invention;

FIG. 8 is a block diagram showing a configuration example of a 3D caption generation unit of FIG. 7;

FIGS. 9A and 9B respectively illustrate a right-eye caption plane and a left-eye caption plane;

FIG. 10 illustrates an appearance of a 3D image;

FIG. 11 is a flowchart for explaining caption display processing;

FIG. 12 illustrates another example of a caption image;

FIG. 13 illustrates another positional relationship between a caption image and a main image in a depth° direction; and

FIG. 14 illustrates a configuration example of an embodiment of a computer.

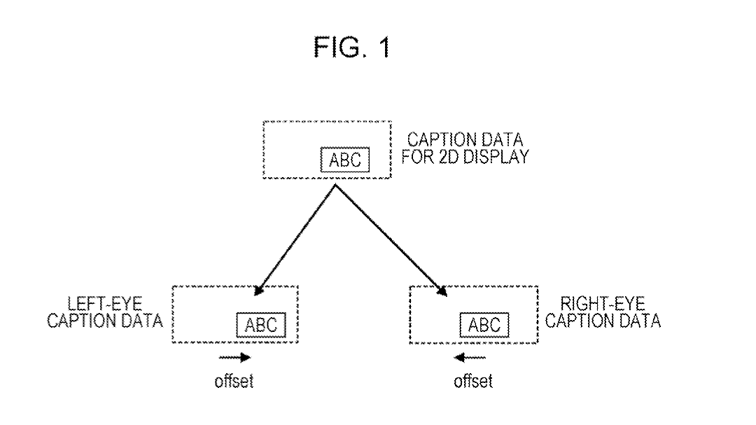

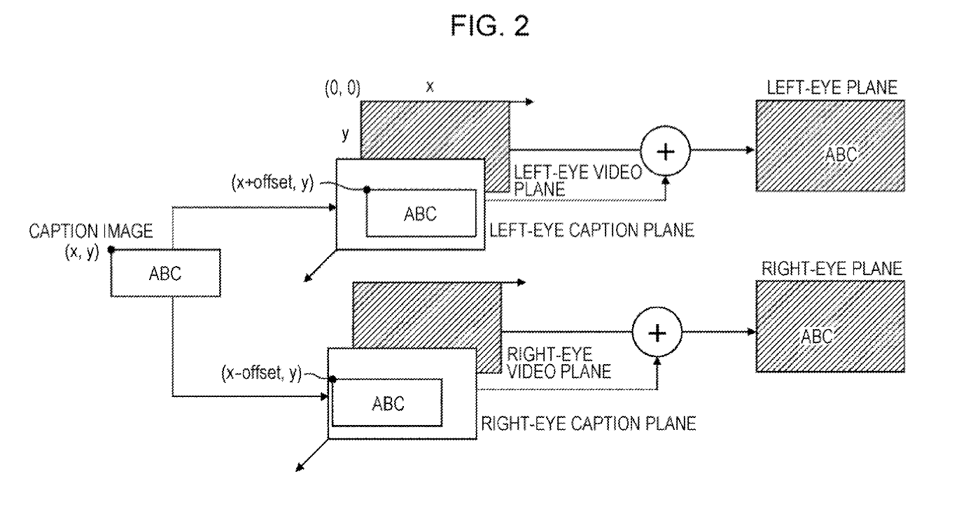

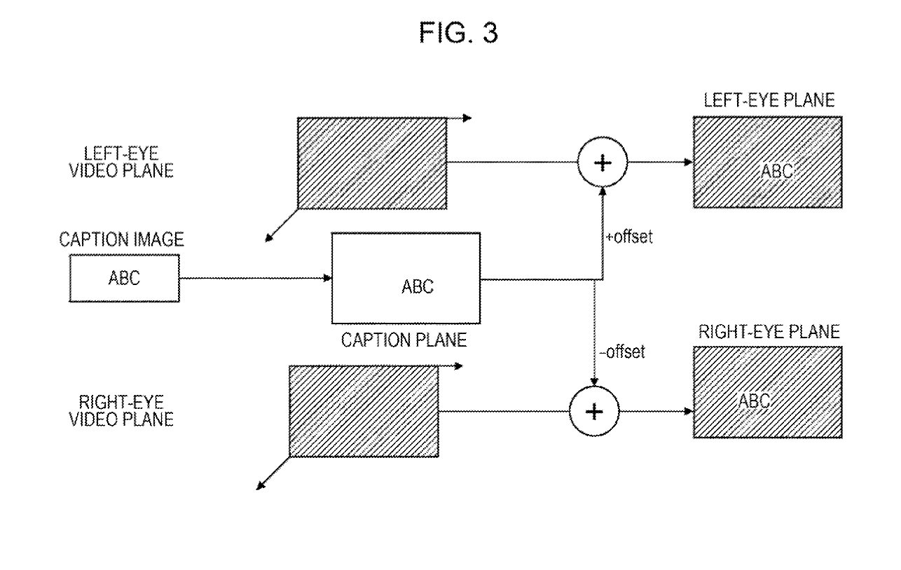

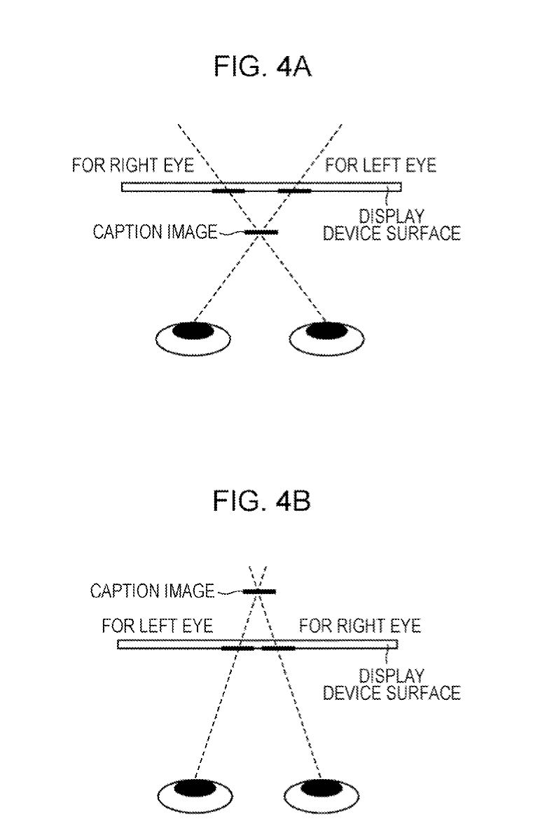

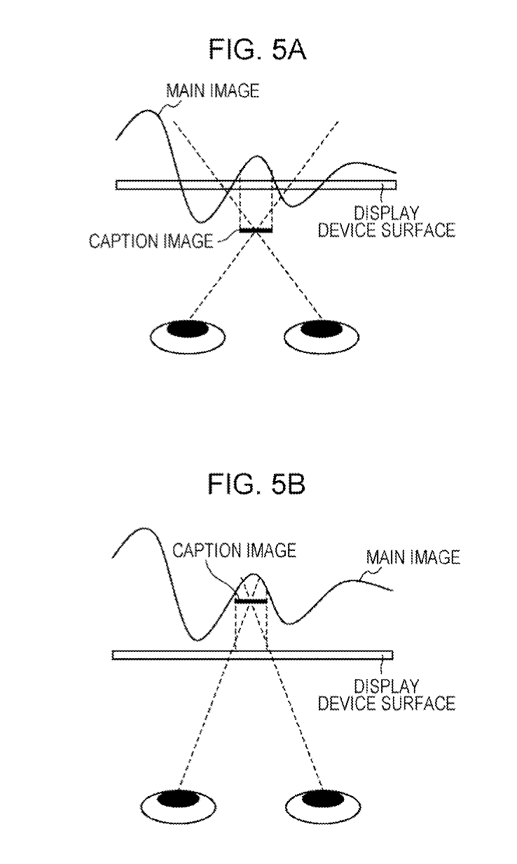

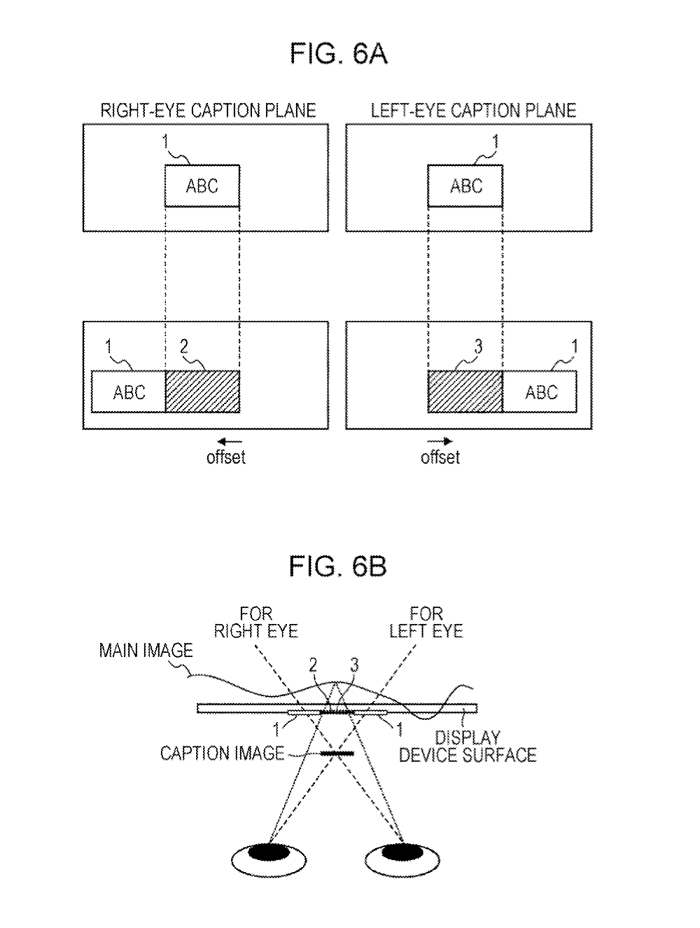

### DESCRIPTION OF THE PREFERRED EMBODIMENTS

### Embodiment

### Configuration Example of an Embodiment of Image Processing Device

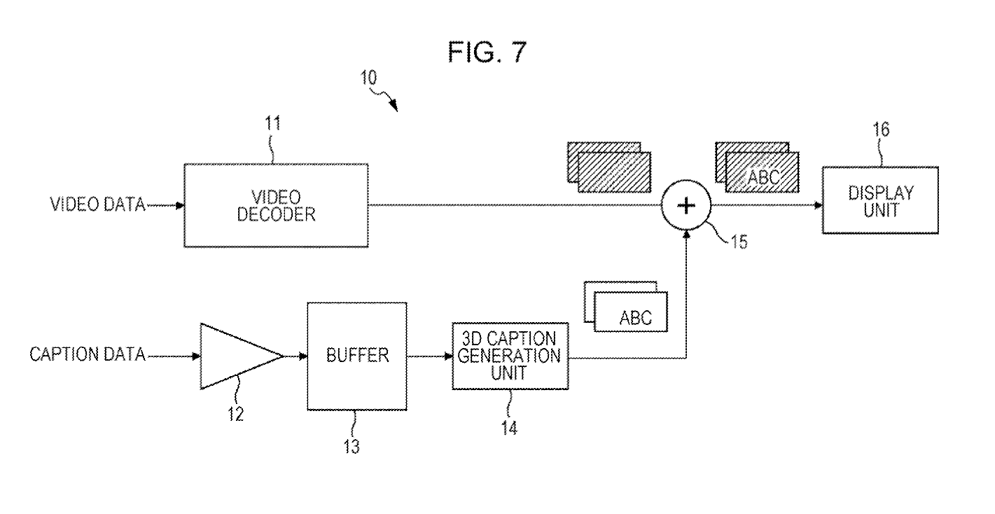

FIG. 7 is a block diagram showing a configuration example of an image processing device according to an embodiment of the present invention.

This image processing device 10 shown in FIG. 7 includes a video decoder 11, a caption decoder 12, a buffer 13, a 3D caption generation unit 14, a superposition unit 15, and a display unit 16. The image processing device 10 performs 3D display of a main image in which a caption image is synthesized by using video data of a main image for 3D display and caption data for 2D display. The video data of a main image for 3D display and the caption data for 2D display are read out of a storage medium such as a Blu-Rays® disc (BD) or received from an external device through the network or the like.

Specifically, video data of a main image for 3D display is inputted into the video decoder 11 of the image processing device 10. The video decoder 11 decodes the inputted video data of the main image for 3D display and supplies a resulting left-eye video plane and a resulting right-eye video plane to the superposition unit 15.

To the caption decoder 12, caption data for 2D display, to which offset amounts offset, a left-eye offset direction, and a right-eye offset direction are added as offset information, is inputted. Here, the offset direction is one direction in a horizontal direction. The left-eye offset direction and the right-eye offset direction are opposite to each other.

The caption decoder 12 performs decode processing with respect to the inputted caption data for 2D display. Further, the caption decoder 12 supplies the caption data obtained as the result of the decode processing and the offset information which is added to the caption data for 2D display to the buffer 13 in a manner to associate the caption data with the offset information. The buffer 13 temporarily maintains the caption data and the offset information which are supplied from the caption decoder 12 in a manner to associate the caption data with the offset data.

The 3D caption generation unit 14 reads out the caption data and the offset information from the buffer 13. The 3D caption generation unit 14 shifts a display position (x, y), which is included in the read out caption data, in the offset direction, which is included in the offset information, by the offset amount offset, which is also included in the offset information. The 3D caption generation unit 14 generates image data of a screen in which a caption image is arranged on a display position (x±offset, y) which is obtained as a result of the shift and a trajectory image (described later in detail) is arranged on a trajectory region of the caption image, as a left-eye caption plane and a right-eye caption plane. The trajectory region is formed when the display position of the caption image is shifted. Then, the 3D caption generation unit 14 supplies the left-eye caption plane and the right-eye caption plane to the superposition unit 15.

The superposition unit 15 superposes the left-eye caption plane received from the 3D caption generation unit 14 on the left-eye video plane received from the video decoder 11 so as to generate a left-eye plane. Further, the superposition unit 15 superposes the right-eye caption plane received from the 3D caption generation unit 14 on the right-eye video plane received from the video decoder 11 so as to generate a right-eye plane. Then, the superposition unit 15 supplies the left-eye plane and the right-eye plane to the display unit 16.

The display unit 16 displays a left-eye screen and a right-eye screen in a time-shared manner, for example, based on the left-eye plane and the right-eye plane which are supplied from the superposition unit 15. At this time, a user wears glasses with a shutter which synchronizes with switches of the left-eye screen and the right-eye screen so as to watch the left-eye screen only by his/her left eye and watch the right-eye screen only by his/her right eye, for example. Accordingly, the user can watch a 3D main image in which a 3D caption is synthesized.

As described above, the image processing device 10 performs 3D display by using the caption data for 2D display, so that the image processing device 10 is compatible with a related art device which is not compatible with the 3D display of captions.

Here, the buffer 13 may not be provided to the image processing device 10.

### Configuration Example of 3D Caption Generation Unit

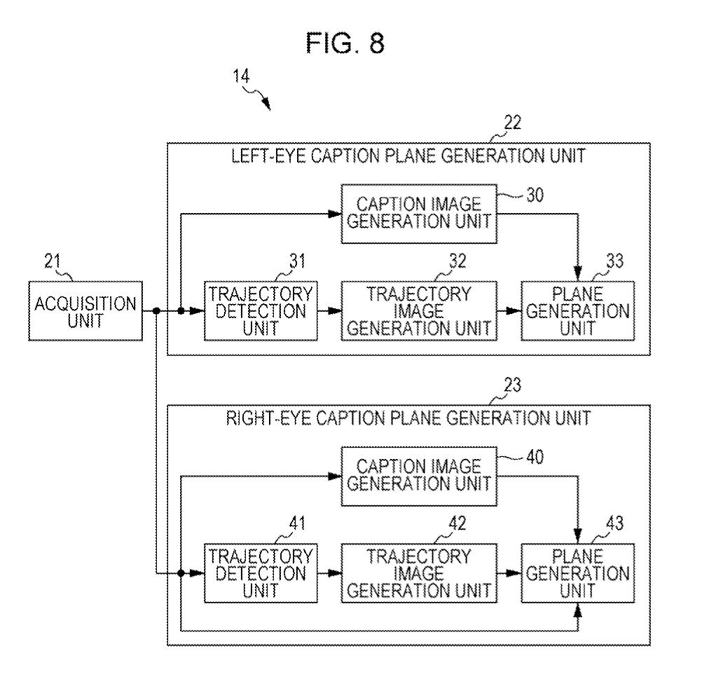

FIG. 8 is a block diagram showing a configuration example of the 3D caption generation unit 14 of FIG. 7.

As shown in FIG. 8, the 3D caption generation unit 14 includes an acquisition unit 21, a left-eye caption plane generation unit 22, and a right-eye caption plane generation unit 23.

The acquisition unit 21 reads out and acquires the caption data and the offset information from the buffer 13. The acquisition unit 21 supplies the caption data, and the offset amount offset and the left-eye offset direction which are included in the offset information to the left-eye caption plane generation unit 22. Further, the acquisition unit 21 supplies the caption data, and the offset amount offset and the right-eye offset direction which are included in the offset information to the right-eye caption plane generation unit 23.

The left-eye caption plane generation unit 22 includes a caption image generation unit 30, a trajectory detection unit 31, a trajectory image generation unit 32, and a plane generation unit 33.

The caption image generation unit 30 shifts a display position included in the caption data which is supplied from the acquisition unit 21 in the left-eye offset direction by the offset amount offset received from the acquisition unit 21, so as to generate left-eye caption data.

The trajectory detection unit 31 detects a position and a size of a trajectory region of the caption image on a left-eye screen. The trajectory region is formed when the caption image corresponding to the caption data which is supplied from the acquisition unit 21 is shifted in the left-eye offset direction by the offset amount offset supplied from the acquisition unit 21. The trajectory detection unit 31 supplies trajectory information expressing the position and the size to the trajectory image generation unit 32.

The trajectory image generation unit 32 generates data for blacking out the trajectory region as trajectory data based on the trajectory information supplied from the trajectory detection unit 31. Specifically, the trajectory image generation unit 32 generates image data of a black image having a size equal to that of the trajectory region (referred to below as a trajectory image), a position of the trajectory region on the left-eye screen as a display position of the image data, and data for specifying an alpha blend amount, which expresses a synthesizing ratio with the main image, to be 1, as trajectory data.

Here, the alpha blend amount has a value from 0 to 1 inclusive. As the alpha blend amount is larger, transparency is lower, and as the alpha blend amount is smaller, the transparency is higher. For example, when the alpha blend amount is 1, image data corresponding to this alpha blend amount is synthesized to be completely opaque. When the alpha blend amount is 0, image data corresponding to this alpha blend amount is synthesized to be completely transparent.

The trajectory image generation unit 32 supplies the trajectory data described above to the plane generation unit 33.

The plane generation unit 33 generates image data of a screen, in which the caption image is arranged on the display position which is included in the left-eye caption data supplied from the caption image generation unit 30 and the trajectory image is arranged on the display position which is included in the trajectory data supplied from the trajectory image generation unit 32, as a left-eye caption plane. Then, the plane generation unit 33 supplies the left-eye caption plane and an alpha blend amount included in the trajectory data to the superposition unit 15. Accordingly, the superposition unit 15 synthesizes the trajectory image of the left-eye caption plane with the left-eye video plane at the alpha blend amount.

The right-eye caption plane generation unit 23 includes a caption image generation unit 40, a trajectory detection unit 41, a trajectory image generation unit 42, and a plane generation unit 43, as is the case with the left-eye caption plane generation unit 22.

Here, processing of respective units of the right-eye caption plane generation unit 23 are same as those of respective units of the left-eye caption plane generation unit 22 except that an offset direction is opposite to the offset direction in the left-eye caption plane generation unit 22 and image data generated by the plane generation unit 43 is a right-eye caption plane. Accordingly, the description of the processing of respective units of the right-eye caption plane generation unit 23 is skipped.

### Explanation of Right-Eye Caption Plane and Left-Eye Caption Plane

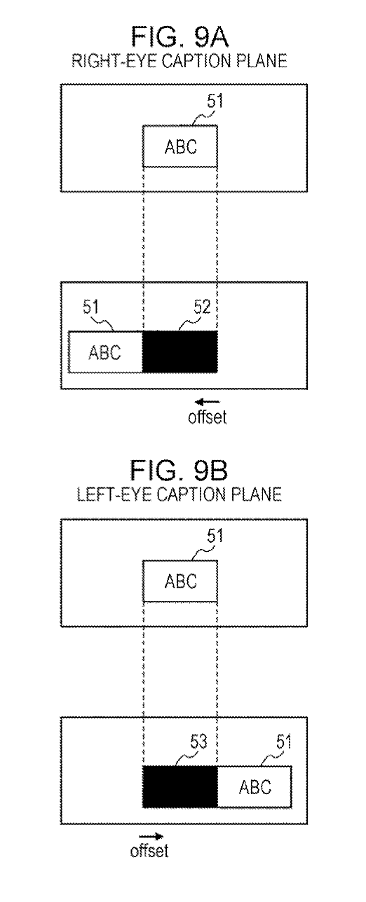

FIGS. 9A and 9B respectively illustrate the right-eye caption plane and the left-eye caption plane which are generated by the 3D caption generation unit 14.

As shown in FIG. 9A, the right-eye caption plane is data of a screen in which a caption image 51 corresponding to caption data for 2D display is shifted in an offset direction (a left direction in the example of FIG. 9A) by an offset amount offset and thus arranged and a trajectory image 52 is arranged in a trajectory region, which is formed in the shift, of the caption image 51.

Further, as shown in FIG. 9B, the left-eye caption plane is data of a screen in which the caption image 51 is arranged shifted in an offset direction (a right direction in the example of FIG. 9B) by an offset amount offset and thus arranged and a trajectory image 53 is arranged in a trajectory region, which is formed in the shift, of the caption image 51.

Here, the caption image 51 is adjacent to the trajectory image 52 in a right-eye screen as shown in FIG. 9A, and the caption image 51 is adjacent to the trajectory image 53 in a left-eye screen as shown in FIG. 9B. Further, the length of the trajectory image 52 and the trajectory image 53 in the vertical direction (up-down direction) is same as that of the caption image 51 and the length of the trajectory images 52 and 53 in the horizontal direction (left-right direction) is the offset amount offset. Thus, the trajectory images 52 and 53 are images having rectangular shapes.

### Appearance of Main Image on which Caption Image is Superposed

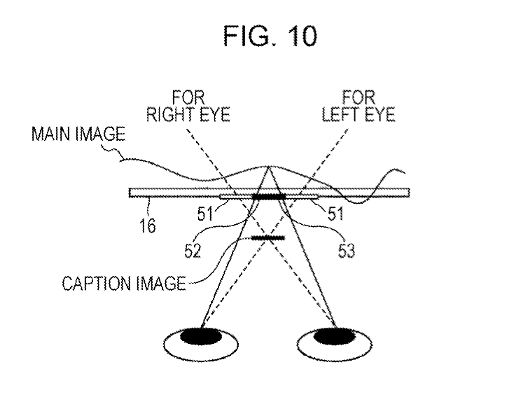

FIG. 10 illustrates an appearance of a 3D image by a left-eye screen and a right-eye screen which are displayed on the display unit 16.

Referring to FIG. 10, an appearance of a 3D image when a left-eye screen and a right-eye screen are displayed by the right-eye plane in which the right-eye caption plane shown in FIG. 9A is synthesized and the left-eye plane in which the left-eye caption plane shown in FIG. 9B is synthesized is described. FIG. 10 is a diagram viewed from the above of a user who watches an image which is displayed on the display unit 16.

As shown in FIG. 10, in a region sandwiched by the caption image 51 on the right-eye screen and the caption image 51 on the left-eye screen, a main image is blacked out by the trajectory image 52 and the trajectory image 53, so that a background of a 3D caption image is not seen from a boundary of the 3D caption image. Accordingly, a focal position of user's eyes does not frequently change, being able to reduce eye strain of the user.

### Explanation of Processing of Image Processing Device

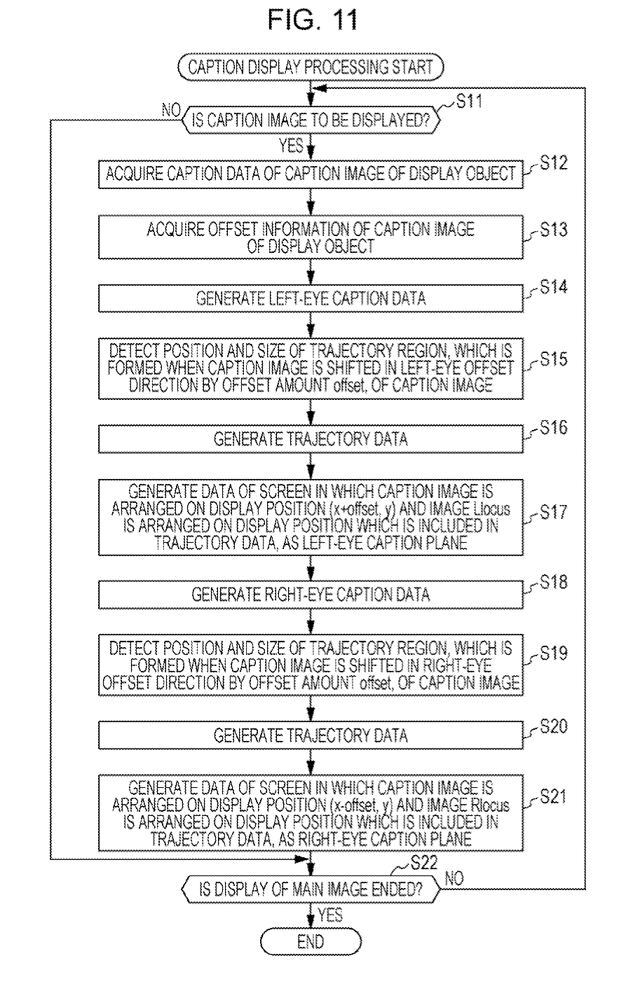

FIG. 11 is a flowchart illustrating caption display processing performed by the 3D caption generation unit 14 of the image processing device 10.

In step S11, the acquisition unit 21 of the 3D caption generation unit 14 determines whether to display a caption image. For example, the acquisition unit 21 determines to display a caption image when display of the caption image is instructed by a user, and the acquisition unit 21 determines not to display a caption image when display of the caption image is not instructed by the user.

When it is determined that a caption image is displayed in step S11, the acquisition unit 21 reads out and acquires caption data of a caption image of a display object from the buffer 13 in step S12.

In step S13, the acquisition unit 21 reads out and acquires offset information of the caption image of the display object from the buffer 13. Then, the acquisition unit 21 supplies the caption data acquired in step S12, and an offset amount offset and a left-eye offset direction which are included in the offset information acquired in step S13 to the left-eye caption plane generation unit 22. Further, the acquisition unit 21 supplies the caption data acquired in step S12, and an offset amount offset and a right-eye offset direction which are included in the offset information acquired in step S13 to the right-eye caption plane generation unit 23.

Here, the left-eye offset direction included in the offset information indicates a positive x direction of an xy coordinate on the screen and the right-eye offset direction indicates a negative x direction, in FIG. 11.

In step S14, the caption image generation unit 30 shifts a display position (x, y), which is included in the caption data supplied from the acquisition unit 21, in the left-eye offset direction by the offset amount offset received from the acquisition unit 21 so as to generate left-eye caption data.

In step S15, the trajectory detection unit 31 detects a position and a size of a trajectory region of the caption image on a left-eye screen. The trajectory region is formed when the caption image corresponding to the caption data supplied from the acquisition unit 21 is shifted in the left-eye offset direction supplied from the acquisition unit 21 by the offset amount offset. The trajectory detection unit 31 supplies trajectory information expressing the position and the size to the trajectory image generation unit 32.

In step S16, the trajectory image generation unit 32 generates data for blacking out the trajectory region as trajectory data based on the trajectory information supplied from the trajectory detection unit 31, and supplies the data to the plane generation unit 33.

In step S17, the plane generation unit 33 generates image data of a screen in which the caption image is arranged on the display position (x+offset, y) which is included in the left-eye caption data supplied from the caption image generation unit 30 and a trajectory image Llocus is arranged on the display position which is included in the trajectory data supplied from the trajectory image generation unit 32, as a left-eye caption plane. Then, the plane generation unit 33 supplies the left-eye caption plane and an alpha blend amount which is included in the trajectory data to the superposition unit 15.

In step S18, the caption image generation unit 40 of the right-eye caption plane generation unit 23 shifts the display position (x, y), which is included in the caption data supplied from the acquisition unit 21, in the right-eye offset direction by the offset amount offset supplied from the acquisition unit 21 so as to generate right-eye caption data.

In step S19, the trajectory detection unit 41 detects a position and a size of a trajectory region of the caption image on a right-eye screen. The trajectory region is formed when the caption image corresponding to the caption data supplied from the acquisition unit 21 is shifted in the right-eye offset direction supplied from the acquisition unit 21 by the offset amount offset. The trajectory detection unit 41 supplies trajectory information expressing the position and the size to the trajectory image generation unit 42.

In step S20, the trajectory image generation unit 42 generates data for blacking out the trajectory region as trajectory data based on the trajectory information supplied from the trajectory detection unit 41, and supplies the data to the plane generation unit 43.

In step S21, the plane generation unit 43 generates image data of a screen in which the caption image is arranged on the display position (x−offset, y) which is included in the right-eye caption data supplied from the caption image generation unit 40 and a trajectory image Rlocus is arranged on the display position which is included in the trajectory data supplied from the trajectory image generation unit 42, as a right-eye caption plane. Then, the plane generation unit 43 supplies the right-eye caption plane and an alpha blend amount which is included in the trajectory data to the superposition unit 15, and the processing goes to step S22.

On the other hand, when it is determined that a caption image is not to be displayed in step S11, processing of steps S12 to S21 are skipped and the processing goes to step S22.

In step S22, the acquisition unit 21 determines whether display of a main image is ended. For example, when an end of the display of the main image is instructed by a user or when an input of video data of the main image for 3D display into the image processing device 10 is ended, the acquisition unit 21 determines that the display of the main image is ended. On the other hand, when the end of the display of the main image is not instructed by the user or when the input of video data of the main image for 3D display into the image processing device 10 is continued, the acquisition unit 21 determines that the display of the main image is not ended.

When it is not determined that the display of the main image is ended in step S22, the processing returns to step S11 and the processing of steps S11 to S22 are repeated until the display of the main image is ended.

On the other hand, when it is determined that the display of the main image is ended in step S22, the processing is ended.

### Another Example of Caption Image

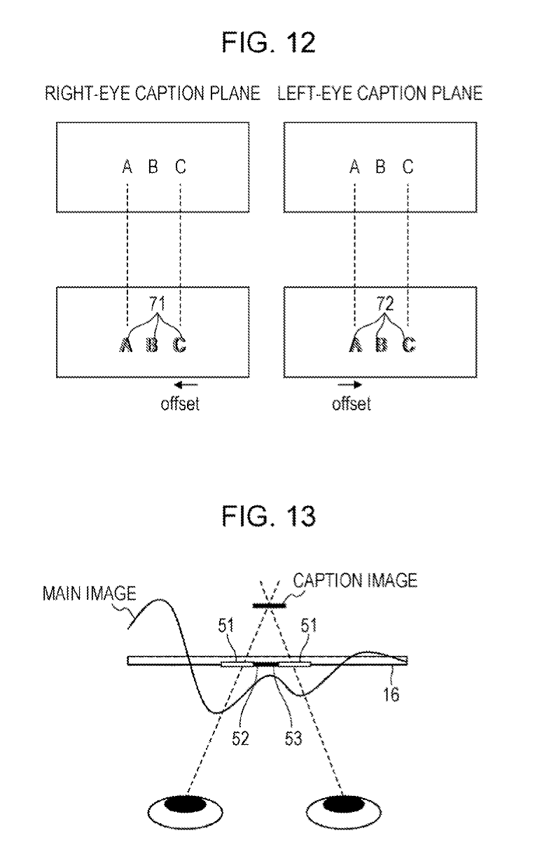

FIG. 12 illustrates another example of the caption image.

A caption image of FIG. 12 is not an image having a rectangular region which includes the whole caption displayed on a single screen as described above but a caption image of a single character unit. In the example of FIG. 12, caption images are an image of “A”, an image of “B”, and an image of “C” as captions.

In this case, image data of a screen is generated as a right-eye caption plane. In the screen, images, which are displayed on a single screen, of respective characters of captions are arranged on positions on which the images are respectively shifted in the right-eye offset direction (a left direction in the example of FIG. 12) from display positions, which are included in caption data for 2D display, by the offset amount offset, as shown in FIG. 12. Then, data for blacking out trajectory regions 71, which are formed when display positions of the images of respective characters of the captions displayed on a single screen are respectively shifted, is generated as trajectory data.

In a similar manner, a plane of a screen is generated as a left-eye caption plane. In the screen, images of the captions in a single character unit are arranged on positions on which the images are respectively shifted in the left-eye offset direction (a right direction in the example of FIG. 12) from the display positions, which are included in the caption data for 2D display, by the offset amount offset. Then, data for blacking out trajectory regions 72, which are formed when the display positions of the images of the captions in the single character unit are respectively shifted, is generated as trajectory data.

In the embodiment, a case where the 3D caption image is displayed at the front side (user side) compared to the 3D main image is described. However, in a case where a 3D caption image is displayed at the back side compared to the 3D main image, as well, a foreground of the 3D caption image is not seen from the boundary of the 3D caption image by superposing the trajectory image 52 and the trajectory image 53 on the main image, as shown in FIG. 13. Accordingly, a focal position of user's eyes does not frequently change, being able to reduce eye strain of the user.

As described above, the image processing device 10 generates left-eye caption data by shifting the display position included in the caption data for 2D display in the left-eye offset direction by the offset amount offset, and generates trajectory data including the trajectory image Llocus which a black image, having low transparency, of the trajectory region formed at the time of the shift. Further, the image processing device 10 processes the right-eye caption data in a similar manner to the left-eye caption data. Then, the image processing device 10 superposes the caption image corresponding to the left-eye caption data and the trajectory image Llocus corresponding to the left-eye trajectory data on the left-eye main image, and superposes the caption image corresponding to the right-eye caption data and the trajectory image Rlocus corresponding to the right-eye trajectory data on the right-eye main image.

Accordingly, a background and a foreground of the 3D caption image are not seen from the boundary of the 3D caption image, as described in FIGS. 10 and 13. Consequently, a focal position of user's eyes does not frequently change, being able to reduce eye strain of the user.

In the above description, the trajectory region is blacked out. However, a color spread in the trajectory region is not limited to black and the color may be gray, a color of the caption, or the like. Further, in the above description, the alpha blend amount of the trajectory image is set to be 1, and the transparency of the trajectory image is set to be 0. However, as long as the main image can be painted out, these are not limited. For example, the alpha blend amount of the trajectory image may be set to be same as the alpha blend amount of the caption image.

Further, the caption data may not include the image data itself of the caption image but may include a character string in which character codes of the caption are described and color information. In this case, the caption decoder 12 generates image data of the caption image based on the character string and the color information.

Further, in the above description, the offset information is supplied in a manner to be added to the caption data. However, the offset information may be preliminarily stored in a storage unit, which is not shown, inside the image processing device 10. In this case, the position of the 3D caption in the depth direction is kept constant at all times.

In the above description, the trajectory region is blacked out. However, the blacked out region is not limited to the trajectory region itself as long as the blacked out region is a region which includes the trajectory region.

The embodiment of the present invention is not limitedly applied to a case where a caption image is synthesized with a main image, and may be applied to a case where a sub image (a menu image, for example) other than a caption image is synthesized with a main image.

### Explanation of Computer According to an Embodiment of the Present Invention

A series of processing described above can be performed by hardware or software. In a case where the series of processing is performed by software, a program constituting the software is installed on a general-purpose computer or the like.

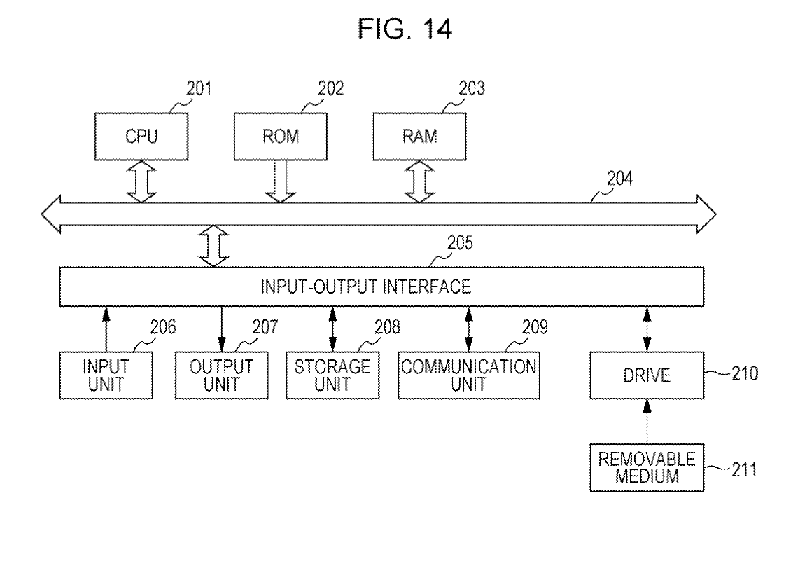

FIG. 14 illustrates a configuration example of an embodiment of a computer on which a program which performs the above-described series of processing is installed.

The program can be preliminarily stored in a storage unit 208 or a read only memory (ROM) 202 which serves as a storage medium built in the computer.

Alternatively, the program can be stored (recorded) in a removable medium 211. Such the removable medium 211 can be provided as so-called packaged software. Here, examples of the removable medium 211 include a flexible disc, a compact disc read only memory (CD-ROM), a magneto optical (MO) disc, a digital versatile disc (DVD), a magnetic disc, and a semiconductor memory.

The program can be installed on the computer from the removable medium 211 described above through a drive 210, or the program can be downloaded into the computer through a communication network or a broadcast network so as to be installed on the storage unit 208 which is built in. That is, the program can be wirelessly transferred to the computer from a download site through a satellite for digital satellite broadcast or can be transferred in a wired fashion through a network such as a local area network (LAN) and an internet, for example.

The computer includes a central processing unit (CPU) 201 built in, and an input-output interface 205 is connected to the CPU 201 through a bus 204.

When an input unit 206 is operated, for example, by a user and thus a command is inputted into the CPU 201 through the input-output interface 205, the CPU 201 executes a program stored in the ROM 202 in accordance with the command. Alternatively, the CPU 201 loads the program stored in the storage unit 208 into a random access memory (RAM) 203 so as to execute the program.

Accordingly, the CPU 201 performs processing following the above-described flowchart or processing performed by the structure of the above-described block diagram. Then, the CPU 201, for example, outputs the processing result from an output unit 207, transmits the processing result from a communication unit 209, or allows the storage unit 208 to store the processing result through the input-output interface 205, as necessary.

The input unit 206 is a key board, a mouse, a microphone, or the like. The output unit 207 is a liquid crystal display (LCD), a speaker, or the like.

In this specification, the processing performed by the computer in accordance with the program is not necessarily performed in a time-series manner of the order described as the flowchart. That is, the processing performed by the computer in accordance with the program includes processing performed in a paratactic manner or in an individual manner (for example, parallel processing or processing by an object), as well.

The program may be processed by a single computer (processor) or may be processed in a distributed manner by a plurality of computers. Further, the program may be transferred to a remote computer and be performed.

The present application contains subject matter related to that disclosed in Japanese Priority Patent Application JP 2009-297547 filed in the Japan Patent Office on Dec. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device, comprising:
a left-eye sub image generation means for generating a left-eye sub image of the left-eye sub image and a right-eye sub image that constitute a sub image for 3D display, by shifting a display position of a sub image for 2D display in a predetermined direction by a predetermined amount;
a right-eye sub image generation means for generating the right-eye sub image by shifting the display position of the sub image for 2D display in a direction opposite to the predetermined direction by the predetermined amount;
a left-eye trajectory image generation means for generating an image, the image having a predetermined color of low transparency, of a left-eye trajectory region that is a region including a trajectory region, the trajectory region being formed when the display position of the sub image for 2D display is shifted in the predetermined direction by the predetermined amount, as a left-eye trajectory image;
a right-eye trajectory image generation means for generating an image, the image having a predetermined color of low transparency, of a right-eye trajectory region that is a region including a trajectory region, the trajectory region being formed when the display position of the sub image for 2D display is shifted in the direction opposite to the predetermined direction by the predetermined amount, as a right-eye trajectory image; and
a superposition means for superposing the left-eye sub image and the left-eye trajectory image on a left-eye main image of the left-eye main image and a right-eye main image that constitute a main image for 3D display, and for superposing the right-eye sub image and the right-eye trajectory image on the right-eye main image.

2. The image processing device according to claim 1, wherein colors of the left-eye trajectory image and the right-eye trajectory image are black.

3. The image processing device according to claim 1, further comprising:
an acquisition means for acquiring the predetermined direction and the predetermined amount, the predetermined direction and the predetermined amount being used for generating a sub image for 3D display corresponding to the sub image for 2D display, as well as the sub image for 2D display.

4. The image processing device according to claim 1, wherein:
the sub image is an image having a rectangular region that includes a whole caption displayed on a single screen;
the left-eye trajectory region is a rectangular region adjacent to the left-eye sub image; and
the right-eye trajectory region is a rectangular region adjacent to the right-eye sub image.

5. The image processing device according to claim 1, wherein:
the sub image is an image of a caption which is in a single character unit;
the left-eye trajectory image is an image, the image having a predetermined color of low transparency, of the left-eye trajectory region of the image of each character of the caption that is displayed on a single screen; and
the right-eye trajectory image is an image, the image having a predetermined color of low transparency, of the right-eye trajectory region of the image of each character of the caption that is displayed on a single screen.

6. An image processing method, in which an image processing device performs the steps of:
shifting a display position of a sub image for 2D display in a predetermined direction by a predetermined Amount so as to generate a left-eye sub image of the left-eye sub image and a right-eye sub image that constitute a sub image for 3D display;
shifting the display position of the sub image for 2D display in a direction opposite to the predetermined direction by the predetermined amount so as to generate the right-eye sub image;
generating an image, the image having a predetermined color of low transparency, of a left-eye trajectory region that is a region including a trajectory region, the trajectory region being formed when the display position of the sub image for 2D display is shifted in the predetermined direction by the predetermined amount, as a left-eye trajectory image;
generating an image, the image having a predetermined color of low transparency, of a right-eye trajectory region that is a region including a trajectory region, the trajectory region being formed when the display position of the sub image for 2D display is shifted in the direction opposite to the predetermined direction by the predetermined amount, as a right-eye trajectory image; and
superposing the left-eye sub image and the left-eye trajectory image on a left-eye main image of the left-eye main image and a right-eye main image that constitute a main image for 3D display, and superposing the right-eye sub image and the right-eye trajectory image on the right-eye main image.

7. A program enabling a computer to perform processing including the steps of:
shifting a display position of a sub image for 2D display in a predetermined direction by a predetermined amount so as to generate a left-eye sub image of the left-eye sub image and a right-eye sub image that constitute a sub image for 3D display;
shifting the display position of the sub image for 2D display in a direction opposite to the predetermined direction by the predetermined amount so as to generate the right-eye sub image;
generating an image, the image having a predetermined color of low transparency, of a left-eye trajectory region that is a region including a trajectory region, the trajectory region being formed when the display position of the sub image for 2D display is shifted in the predetermined direction by the predetermined amount, as a left-eye trajectory image;
generating an image, the image having a predetermined color of low transparency, of a right-eye trajectory region that is a region including a trajectory region, the trajectory region being formed when the display position of the sub image for 2D display is shifted in the direction opposite to the predetermined direction by the predetermined amount, as a right-eye trajectory image; and
superposing the left-eye sub image and the left-eye trajectory image on a left-eye main image of the left-eye main image and a right-eye main image that constitute a main image for 3D display, and superposing the right-eye sub image and the right-eye trajectory image on the right-eye main image.

8. An image processing device, comprising:
a left-eye sub image generation unit configured to generate a left-eye sub image of the left-eye sub image and a right-eye sub image that constitute a sub image for 3D display, by shifting a display position of a sub image for 2D display in a predetermined direction by a predetermined amount;
a right-eye sub image generation unit configured to generate the right-eye sub image by shifting the display position of the sub image for 2D display in a direction opposite to the predetermined direction by the predetermined amount;
a left-eye trajectory image generation unit configured to generate an image, the image having a predetermined color of low transparency, of a left-eye trajectory region that is a region including a trajectory region, the trajectory region being formed when the display position of the sub image for 2D display is shifted in the predetermined direction by the predetermined amount, as a left-eye trajectory image;
a right-eye trajectory image generation unit configured to generate an image, the image having a predetermined color of low transparency, of a right-eye trajectory region that is a region including a trajectory region, the trajectory region being formed when the display position of the sub image for 2D display is shifted in the direction opposite to the predetermined direction by the predetermined amount, as a right-eye trajectory image; and
a superposition unit configured to superpose the left-eye sub image and the left-eye trajectory image on a left-eye main image of the left-eye main image and a right-eye main image that constitute a main image for 3D display, and to superpose the right-eye sub image and the right-eye trajectory image on the right-eye main image.
